(19) United States
(12) Patent Application Publication
(10) Pub. No.: US 2012/0278590 A1
(43) Pub. Date: Nov. 1, 2012

(54) RECONFIGURABLE PROCESSING SYSTEM AND METHOD

(75) Inventors: Kenneth Chenghao Lin, Shanghai (CN); Zhongmin Zhang, Shanghai (CN); Haoqi Ren, Shanghai (CN)

(73) Assignee: SHANGHAI XIN HAO MICRO ELECTRONICS CO. LTD., Shanghai (CN)

(21) Appl. No.: 13/520,545

(22) PCT Filed: Jan. 7, 2011
(86) PCT No.: PCT/CN11/70106

§ 371 Date: Jul. 3, 2012

(30) Foreign Application Priority Data
Jan. 8, 2010 (CN) 201010022606.7

(51) Int. Cl. G06F 15/76

(52) U.S. Cl. 712/30; 712/E09.003

(57) ABSTRACT

A reconfigurable processor is provided. The reconfigurable processor includes a plurality of functional blocks configured to perform corresponding operations. The reconfigurable processor also includes one or more data inputs coupled to the plurality of functional blocks to provide one or more operands to the plurality of functional blocks, and one or more data outputs to provide at least one result outputted from the plurality of functional blocks. Further, the reconfigurable processor includes a plurality of devices configured to inter-connect the plurality of functional blocks such that the plurality of functional blocks are independently provided with corresponding operands from the data inputs and individual results from the plurality of functional blocks are independently feedback as operands to the plurality of functional blocks to carry out one or more operation sequences

### TECHNICAL FIELD

The present invention generally relates to the field of integrated circuit and, more particularly, to systems and methods for reconfiguring processing resources to implement different operation sequence.

### BACKGROUND ART

Demands on integrated circuit (IC) functionalities have been dramatically increased with technology progresses and increasing demands for multimedia applications. IC chips are required to support high-speed stream data processing, to perform a large amount of high-speed data operations, such as addition, multiplication, Fast Fourier Transform (FFT), and Discrete Cosine Transform (DCT), etc., and are also required to be able to have functionality updates to meet new demands from a fast-changing market.

A conventional central processing unit (CPU) and a digital signal processing (DSP) chip is flexible in functionality, and can meet requirements of different applications via updating relevant software application programs. However, the CPUs, which have limited computing resources, often have a limited capability on stream data processing and throughput. Even in a multi-core CPU, the computing resources for stream data processing are still limited. The degree of parallelism is limited by the software application programs, and the allocation of computing resources is also limited, thus the throughput is not satisfactory. Comparing with the general purpose CPUs, the DSP chips enhance stream data processing capability by integrating more mathematical and execution function modules. In certain chips, multipliers, adders, and bit-shifters are integrated in to a basic module, which can then be used repeatedly within the chip to provide sufficient computation resources. However, these types of chips are difficult to reconfigure and are often inflexible in certain applications.

Further, an application specific integrated circuit (ASIC) chip may be designed for high-speed stream data processing and with high data throughput. However, each ASIC chip requires custom design that is inefficient in terms of time and cost. For instance, the non-recurring engineering cost can easily go beyond several million dollars for an ASIC chip designed in a 90 nm technology. Also, an ASIC chip is not flexible and often cannot change functionality to meet changing demands of the market, and generally needs a re-design for upgrade. In order to integrate different operations in one ASIC chip, all operations have to be implemented in separate modules to be selected for use as needed. For instance, in an ASIC chip capable of processing more than one video standards, more than one set of decoding modules for multiple standards are often designed and integrated in the same chip, although only one set of the decoding modules are used at one time. This may cause both higher design cost and high production cost of the ASIC chip.

### DISCLOSURE OF INVENTION

### Technical Problem

Conventional processor such as CPUs and DSPs are flexible in function re-define. However, the processors often do not meet the throughput requirement for various different applications. ASIC chips and SOCs implemented by place and route physical design methodology have high throughput at a price of long design time, high design cost and NRE cost. Field programmable device is both flexible and high throughput. However, the current field programmable device is low in performance and high in cost.

### Technical Solution

One aspect of the present invention includes a reconfigurable processor. The reconfigurable processor includes a plurality of functional blocks configured to perform corresponding operations. The reconfigurable processor also includes one or more data inputs coupled to the plurality of functional blocks to provide one or more operands to the plurality of functional blocks, and one or more data outputs to provide at least one result outputted from the plurality of functional blocks. Further, the reconfigurable processor includes a plurality of devices configured to inter-connect the plurality of functional blocks such that the plurality of functional blocks are independently provided with corresponding operands from the data inputs and individual results from the plurality of functional blocks are independently feedback as operands to the plurality of functional blocks to carry out one or more operation sequences.

Another aspect of the present disclosure includes a reconfigurable processor. The reconfigurable processor includes a plurality of processor cores and a plurality of connecting devices configured to inter-connect the plurality of processor cores. The plurality of processor cores include at least a first processor core and a second processor core. Both the first and second processor cores have a plurality of functional blocks configured to perform corresponding operations. Further, the first processor core is configured to provide a first functional module using one or more of the plurality of functional blocks of the first processor, and the second processor core is configured to provide a second function module using one or more of the plurality of functional blocks of the second processor. The first function module and the second functional module are integrated based on the plurality of connecting devices to form a multi-core functional module.

Other aspects of the present disclosure can be understood by those skilled in the art in light of the description, the claims, and the drawings of the present disclosure.

### Advantageous Effects

The disclosed systems and methods may provide solutions to improve the utilization of functional blocks in a single core or multi-core processor. The functional blocks in the single core or multi-core processor can be reconfigured to form different functional modules for specific operation sequences under control of corresponding control signals, and thus condense operation may be implemented. The condense operation as disclosed herein may perform multiple operations in a single clock cycle by forming a local pipeline with multiple functional blocks in a single process core or multiple processor cores and perform operations on the functional blocks simultaneously. By using the disclosed systems and methods, computing efficiency, performance and throughput can be significantly improved for a single core or multi-core processor system.

Further, the disclose systems and methods are programmable and configurable. Based on a basic re-configurable processor, chips for various different applications may be implemented by way of changing the programming and configuration. The disclosed systems and methods are also capable of reprogram and re-configure a processor chip in-run time, thus enable the time-sharing of the cores and functional blocks.

Other advantages may be obvious to those skilled in the art.

### DESCRIPTION OF DRAWINGS

FIG. 1 illustrates a block diagram of an arithmetic logic unit (ALU) used in a conventional CPU;

FIG. 2 illustrates an exemplary ALU consistent with the disclosed embodiments;

FIG. 3 illustrates an exemplary operation configuration of an ALU consistent with the disclosed embodiments;

FIG. 4 illustrates another exemplary operation configuration of an ALU consistent with the disclosed embodiments;

FIG. 5 illustrates an exemplary ALU coupled with other CPU components consistent with the disclosed embodiments;

FIG. 6 illustrates an exemplary storage unit storing reconfiguration control information consistent with the disclosed embodiments;

FIG. 7 illustrates an exemplary logic unit with expanded functionality consistent with the disclosed embodiments;

FIG. 8 illustrates an exemplary three-input multiplier consistent with the disclosed embodiments;

FIG. 9 illustrates an exemplary first-in-first-out (FIFO) buffer consistent with the disclosed embodiments;

FIG. 10 illustrates an exemplary serial/parallel data convertor consistent with the disclosed embodiments;

FIG. 11A illustrates an exemplary multi-core structure consistent with the disclosed embodiments;

FIG. 11B illustrates an exemplary inter-connection across different processor cores consistent with the disclosed embodiments;

FIG. 11C illustrates another exemplary multi-core structure consistent with the disclosed embodiments;

FIG. 12 illustrates an exemplary multi-core structure implemented by configuring ALUs in multiple processor cores consistent with the disclosed embodiments;

FIG. 13A illustrates an exemplary multi-core structure consistent with the disclosed embodiments;

FIG. 13B illustrates an exemplary block diagram of a 2³-point, i.e., eight-point, FFT using twelve butterfly units consistent with the disclosed embodiments;

FIG. 13C illustrates another exemplary multi-core structure consistent with the disclosed embodiments;

FIG. 13D illustrates another exemplary multi-core structure consistent with the disclosed embodiments;

FIG. 13E illustrates another exemplary multi-core structure consistent with the disclosed embodiments;

FIG. 13F illustrates another exemplary multi-core structure consistent with the disclosed embodiments;

FIG. 13G illustrates another exemplary multi-core structure consistent with the disclosed embodiments; and

FIG. 13H illustrates another exemplary multi-core structure consistent with the disclosed embodiments.

### BEST MODE

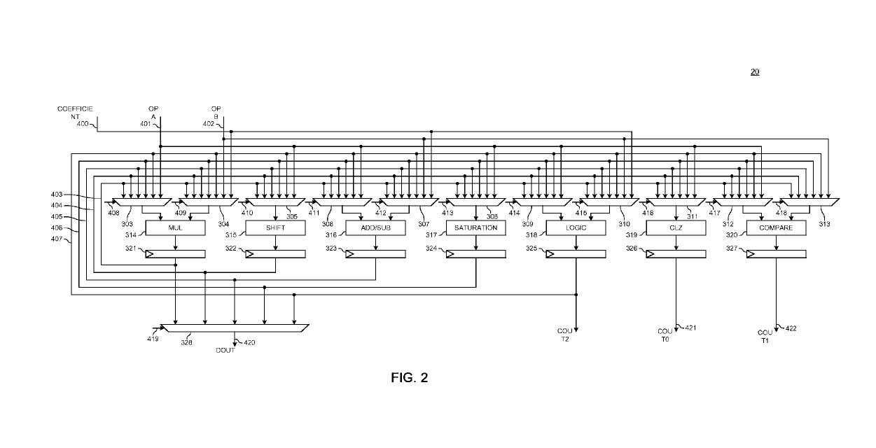

FIG. 2 illustrates an exemplary preferred embodiment(s).

### Mode for Invention

Reference will now be made in detail to exemplary embodiments of the invention, which are illustrated in the accompanying drawings. The same reference numbers may be used throughout the drawings to refer to the same or like parts.

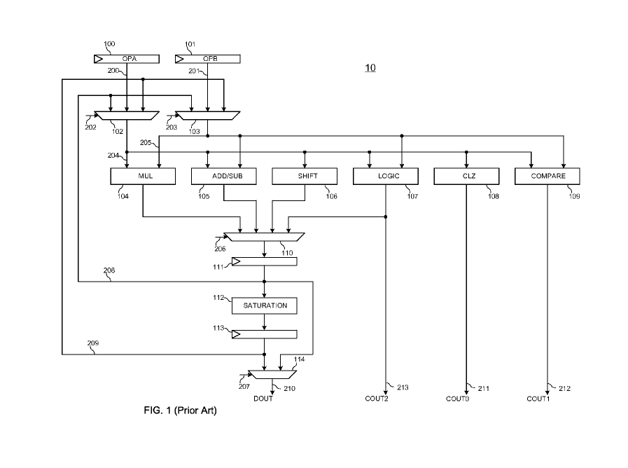

FIG. 1 illustrates a block diagram of an arithmetic logic unit (ALU) 10 used in a conventional CPU. As shown in FIG. 1, the ALU 10 includes registers 100, 101, 111, and 113; multiplexers 102, 103, 110, and 114; and several functional blocks, including multiplier 104, adder/subtractor 105, shifter 106, logic unit 107, saturation processor 112, leading zero detector 108, and comparator 109.

Registers 100, 101, 111, and 113 are provided for holding operands or results, and multiplexers 102 and 103 are provided to select the same operands for all the various functional units at any given time. Multiplexers 110 and 114 are provided to select outputs. Bus 200 and bus 201 are operands from registers 100 and 101, and bus 208 and bus 209 are data bypasses of previous operation results. The multiplexers 102 and 103 select operands 204 and 205 for operation under the control of control signals 202 and 203, respectively. One set of operands may be selected for all the functional blocks at any given time. And the selected operands 204 and 205 are further processed by one of the functional blocks 104, 105, 106, 107, 108 and 109 that require the operands for operation. Multiplexer 110 under the control of signal 206 selects one of the four operation results from functional blocks 104, 105, 106, and 107, and the selected result is stored in the register 110. The output of 110 is then fed back on bus 208, and further selected by multiplexers 102 and 103, as the operand 205 for next instruction operation. And bus or signal 209 is a feedback of the result from operation unit 112 to the multiplexers 102 and 103.

Output signals from functional blocks 104, 105, 106, 107, 108 and 109 may be further processed. Signals from functional blocks 104, 105, 106, and 107 are selected by the multiplexer 110 for saturation processing in saturation processor 112 or for generating a data output 210 through multiplexer 114. Control signal 206 and 207 are used to control multiplexer 110 and 114 to select different multiplexer in puts. Further, the signals 211 and 212 generated by the leading zero detector 108 and the comparator 109, respectively, and the signal 213 generated by the logic unit 107 may also be outputted. The control signals 202, 203, 206 and 207 control various multiplexers.

Thus, in conventional ALU 10, one instruction execution completes one operation of the ALU 10. That is, although several functional blocks are available, only one function block performs a valid operation during a particular clock cycle, and sources providing operands to the functional blocks are fixed, from a register file or a bypass from the results of a previous operation.

FIG. 2 illustrates an exemplary block diagram of an ALU 20 of a reconfigurable process or consistent with the disclosed embodiments. The ALU 20 includes pipeline registers 321, 322, 323, 324, 325, 326, and 327; multiplexers 303, 304, 305, 306, 307, 308, 309, 310, 311, 312, 313, and 328; and a plurality of functional blocks.

Pipeline registers 321, 322, 323, 324, 325, 326, and 327 may include any appropriate registers for storing intermediate data between pipeline stages. Multiplexers 303, 304, 305, 306, 307, 308, 309, 310, 311, 312, 313, and 328 may include any multiple-input multiplexer to select an input under a control signal. Further, the plurality of functional blocks may include any appropriate arithmetic functional blocks and logic functional blocks, including, for example, multiplier 314, adder/subtractor 316, shifter 315, saturation block 317, logic unit 318, leading zero detector 319, and comparator 320. Certain functional blocks may be omitted and other functional blocks may be added without departing the principle of the disclosed embodiments.

Buses 400, 401, and 402 provide inputs to the functional blocks, and the inputs or operands may be from certain pipeline registers. The operand on bus 400 (COEFFICIENT) may be referred as a coefficient, which may change less frequently during operation, and may be provided to certain functional blocks, such as multiplier 314, adder/subtractor 316, and logic unit 318. Operands on bus 401 and bus 402 (OPA, OPB) may be provided to all functional blocks independently. Further, buses 403, 404, 405, 406, and 407 provide independent data bypasses of previous operation results of multiplier 314, adder/subtractor 316, shifter 315, saturation processor 317, and logic unit 318 as operands for operations in a next clock cycle or calculation cycle. Results generated by functional blocks may be stored in the corresponding registers. The registers may feedback all or part of the results to the functional units as data sources for the next pipelined operation by the functional blocks. At the same time, the registers may also output one or more control signals for the multiplexers to select final outputs.

A data out 420 (DOUT) is selected for output from results of multiplier 314, adder/subtractor 316, shifter 315, saturation block 317, and logic unit 318 by multiplexer 328, after passing pipeline registers 321, 322, 323, 324, and 325, respectively. The outputs 421 and 422 (COUT0, COUT1) generated by the leading zero detector 319 and the comparator 320, respectively, may be used as condition flags used to generate control signals, and the output 413 (COUT2) generated by the logic unit 318 may also be used for the same purpose. Further, control signals 408, 409, 410, 411, 412, 413, 414, 415, 416, 417 and 418 are provided to respectively control multiplexers 303, 304, 305, 306, 307, 308, 309, 310, 311, 312 and 313 to select individual operands as the inputs to the corresponding functional blocks. Control signal 419 is provided to control multiplexer 328 to select an output from operation results of multiplier 314, adder/subtractor 316, shifter 315, saturation processor 317, and logic unit 318. These control signals may be generated by configuration information, which will be described in detail later, or by decoding of the instruction by corresponding decoding logic (not shown). Outputs from the registers, as well as control signals to the multiplexers may be generated or configured by the configuration information.

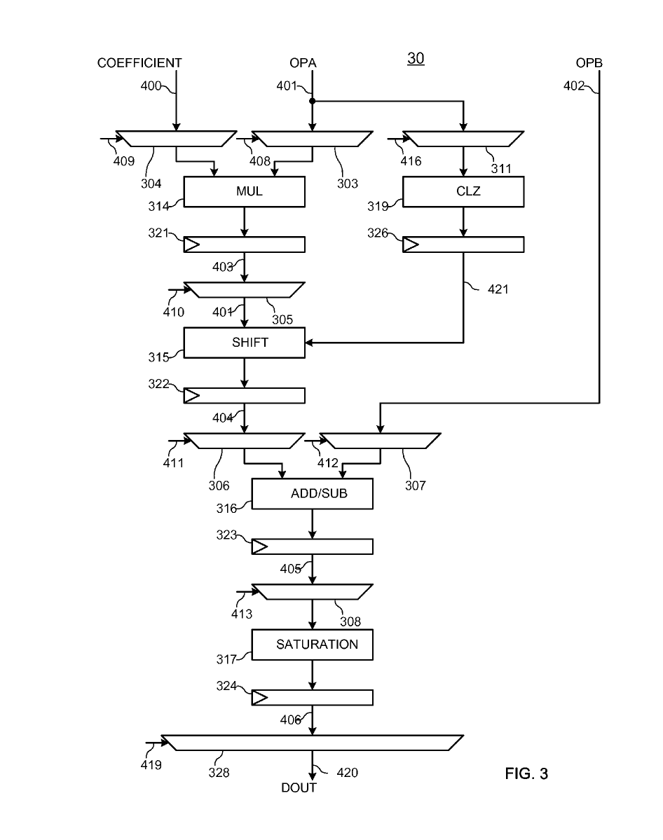

That is, in ALU 20, outputs from various individual functional blocks are fed back to various multiplexers as inputs through data bypasses, and each of the functional blocks have separate multiplexers, such that different functional blocks may perform parallel valid operations by properly configuring the various multiplexers and/or functional blocks. In other words, the various interconnected functional blocks may be configured to support a particular series of operations and/or series of operations on a series of similar data (a data stream). The various pipeline registers, multiplexers, and signal lines (e.g., inputs, outputs, and controls) may form the interconnection to configure the functional blocks. Such configuration or reconfiguration may be performed before run-time or during run-time. Besides performing the regular ALU function as in a normal CPU, the disclosure enables the utilization of functional blocks through configuration so that multiple functional blocks operate in the same cycle in a relay or pipeline fashion. FIG. 3 illustrates an exemplary operation configuration 30 of ALU 20 consistent with the disclosed embodiments.

In FIG. 3, a functional-equivalent pipeline performing relay operations is implemented by configuring ALU 20. The series of operations include: multiplying an operand A by a coefficient C, shifting the product and then adding the shifted product to an operand B, and performing a saturation operation to generate an output. As shown in FIG. 3, four functional blocks (multiplexer 314, shifter 315, adder 316 and saturation processor 317) from ALU 20 may be used to implement the aforementioned series of operations. These blocks along with any corresponding interconnections, such as control signals, and other components, may be referred as a functional module or a reconfigurable functional module. An ALU with a reconfigurable functional module may be considered as a reconfigurable ALU, and a CPU core with a reconfigurable function module may be considered as a reconfigurable CPU core.

During operation, control signals 408, 409, 410, 411, 412, 413, and 416 may controls the multiplexers 303, 304, 305, 306, 307, 308, and 311 to select proper input operands for corresponding functional blocks to perform relay operations in parallel. Control signal 419 may control the multiplexer 328 to select proper execution block result to be outputted on DOUT 420. More particularly, control signal 409 is configured to control multiplexer 304 selecting coefficient 400 as one operand to multiplier 314 and control signal 408 is configured to control multiplexer 303 selecting operand A (OPA) on bus 401 as another operand to multiplier 314. The multiplier 314 can thus compute a product of operand A and coefficient C. The resulted product passes pipeline register 321 and is fed back through data bypass 403.

Control signal 410 is configured to select 403 as output of multiplexer 305 such that the previous computed product is now provided to shifter 315 as an input operand for the shifting operation. Control signal 416 is also configured to select operand A as output of multiplexer 311, which is further provided to leading zero detector 319 for leading zero detection operation, and the result 421 may be provided as shift amount for the shifting operation. The shifted product outputted from pipeline register 322 again is fed back through data bypass 404.

Further, control signal 411 is configured to select the previously computed shifted product 404 as output of multiplexer 306, and control signal 412 is configured to select operand B on bus 402 (OPB) as output of multiplexer 307 such that adder/subtractor 316 can compute a n addition of the previously computed shifted product and the operand B. The added result from adder/subtractor 316 passes through pipeline register 323 and is fed back through data bypass 405.

Control signal 413 is configured to select 405 as output of multiplexer 308 such that the previous added result is now provided to saturation block 317 for saturation operation. The final result is then outputted through pipeline register 324 and selected by control signal 419 as the output of multiplexer 328 (i.e., DOUT 420).

Thus, the series of operations are performed by separate functional blocks in a series of steps or stages, which may be treated as a pipeline of the functional blocks (also may be called a local-pipeline or mini-pipeline). For example, when inputting a data stream for processing, during every clock cycle, a new set of operands may be provided on buses 400, 401 and 402, and a new data output may be provided on bus 420. Further, functional blocks can independently perform corresponding steps or operations such that a parallel processing of a data flow or data stream using the pipeline can be implemented.

In addition, because multiplier 314 and leading zero detector 319 both uses operand A on bus 401, multiplier 314 and leading zero detector 319 can be configured to operate in parallel. Leading zero detector 319 may generate a result to be provided to shifter 315 to determine the number of bits to be shifted on the product result from multiplier 314. That is, coefficient 400 and OPA 401 are provided as two inputs to multiplier 314. The product generated by multiplier 314 is shifted by the amount equals to the number of leading zeros provided by leading zero detector 319. This result and OPB 402 are then added by Adder 316. The sum is saturated by saturation logic 317 and is selected by control signal 419 at multiplexer 328 as DOUT 420.

Further, the series of operations may be invoked in a computer program. For example, a new instruction may be created to designate a particular type of series of operations, where each functional block executes one of the operations. That is, functional blocks in a reconfigurable CPU core implementing different functions are integrated according to input instructions. One functional block may be coupled to receive the outputs from a precedent functional block, and generates one or multiple outputs used as input(s) to a subsequent functional block. Each functional block repeats the same operation every time it receives new inputs.

Return to FIG. 2, because results of all functional blocks are stored in corresponding registers 321-327, and the outputs of the registers are fed back to inputs of the functional blocks, the registers 321-327 are referred as pipeline registers, and the functional blocks between two pipeline registers (functionally) may be considered as a pipeline stage. The functional blocks may thus be connected in a sequence in operation under control of corresponding control signals, and thus a local-pipeline of operation may be implemented. Although conventional CPU can use pipeline operations to process multiple instruction in a single clock cycle, the conventional CPU often only executes (through the functional unit) one instruction in one clock cycle. However, the local-pipeline as disclosed herein may execute multiple operations in a single clock cycle by using multiple functional blocks in the execution unit simultaneously.

Further, various operation sequences may be defined using the various functional blocks of ALU 20 to implement a pipelined operation to improve efficiency. For example, assuming a sequence (Seq. 1) is defined to perform addition (ADD), comparison (COMP), saturation (SAT), multiplication (MUL) and finally selection (SEL), a total of five operations in a sequence, and for a stream of data (Data 1, Data 2, . . . , Data 6), Table 1 below shows a pipelined operation (each cycle may refer to a clock cycle or a calculation cycle) applied to a plurality of data inputs (Data 1, Data 2, . . . , Data 6).

TABLE 1
Sequence and illustrated pipeline operation

| | Se- | Cycle | Cycle | Cycle | Cycle | Cycle | Cycle |
|---|---|---|---|---|---|---|---|
| Data | quence | 1 | 2 | 3 | 4 | 5 | 6 |
| Data 1 | Seq. 1 | ADD | COMP | SAT | MUL | SEL | |
| Data 2 | Seq. 1 | | ADD | COMP | SAT | MUL | SEL |
| Data 3 | Seq. 1 | | | ADD | COMP | SAT | MUL |
| Data 4 | Seq. 1 | | | | ADD | COMP | SAT |
| Data 5 | Seq. 1 | | | | | ADD | COMP |
| Data 6 | Seq. 1 | | | | | | ADD |

Thus, during a fully pipelined operation, at any cycle, there may be four operations and one SEL being performed at the same time (as shown in Cycles 5 & 6). An operation sequence may be defined in any length using available functional blocks, but may be limited by the number of available functional blocks, because one operation unit may be used only once in the operation sequence to avoid any potential resource conflict in pipelined operation. Further, the pipeline stages or steps may be configured based on a particular application or even dynamically based on inputted data stream. Other configurations may also be used.

In other words, the reconfigurable processor or reconfigurable CPU, in addition to support instructions for the normal CPU (e.g., without the inter-connections to the functional blocks) (i.e., a first mode or a normal operation mode), also supports a second mode or a condense operation mode, under which the reconfigurable CPU is capable performing condense operations (i.e., an operation utilizing more than one functional blocks per clock cycle to perform more than one operations) so as to improve the operation throughput.

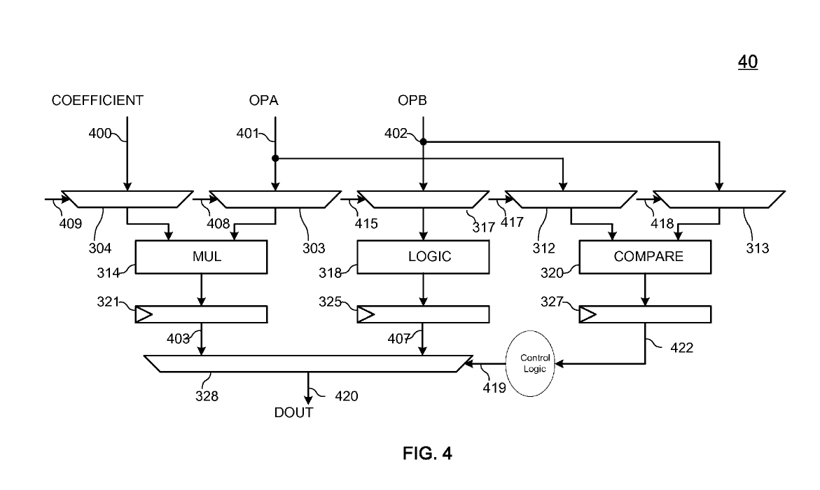

FIG. 4 illustrates another exemplary operation configuration 40 for a compare-and-select operation consistent with the disclosed embodiments. In FIG. 4, in a series of operations corresponding to the compare-and-select operation, two operands are compared, and one of the operand is selected as an output based on the comparison result. As shown in FIG. 4, such series of operations may be implemented by configuring the multiplexer 314, logic unit 318, and comparator 320. In particular, the controls 417 and 418 are configured to select operand A and operand B on bus 401 and 402, respectively, as outputs of the multiplexers 312 and 313, such that the comparator 320 can perform a comparison operation of operand A and operand B. The result of the comparison may be outputted as output 422 through pipeline register 327, and a control logic may be implemented based on output 422 to generate control signal 419.

At the same time, control signal 408 is configured to select the coefficient input 400 as output of multiplexer 303, and control signal 409 is configured to select operand A as the output of multiplexer 304, such that multiplexer 314 can perform a multiplication of coefficient 400 and operand A. Further, if the coefficient input 400 is kept as ‘1’, the multiplier 314 may thus provide a single operand A.

Meanwhile, control signal 415 is configured to select operand B on bus 402 as output of multiplexer 317, such that logic unit 318 can perform a logic operation on operand B. If the logic operation is an ‘AND’ operation between the operand B 402 and a logic ‘1’, logic unit 318 may provide a single operand B.

Therefore, the outputs of the multiplier 314 and logic unit 318 are equal to the inputted operands A and B on buses 401 and 402, and are outputted as 403 and 407 through pipeline registers 321 and 325, respectively, one of which is selected as output 420 of multiplexer 328. The control signal 419 for selecting between 403 and 407 is determined based on the result of the operation of comparator 320. Because the operation of comparator 320 is a comparison between operand A and operand B, the comparison between operand A and operand B is used to output one of operand A and operand B (i.e., between 403 and 407).

As above disclosed, the multiplier 314 and the logic unit 318 are configured to transfer the input operand data 401 and 402. The adder 316 may also be configured to transfer data similarly, based on particular applications. The above disclosed efficient compare-and-select operations may be used in many data processing applications, such as in a Viterbi algorithm implementation. In addition, the functional blocks 315, 316 and 317 may also be used or integrated for parallel operations in certain embodiments. The data out 420 is selected according to the control 419 generated by the control logic.

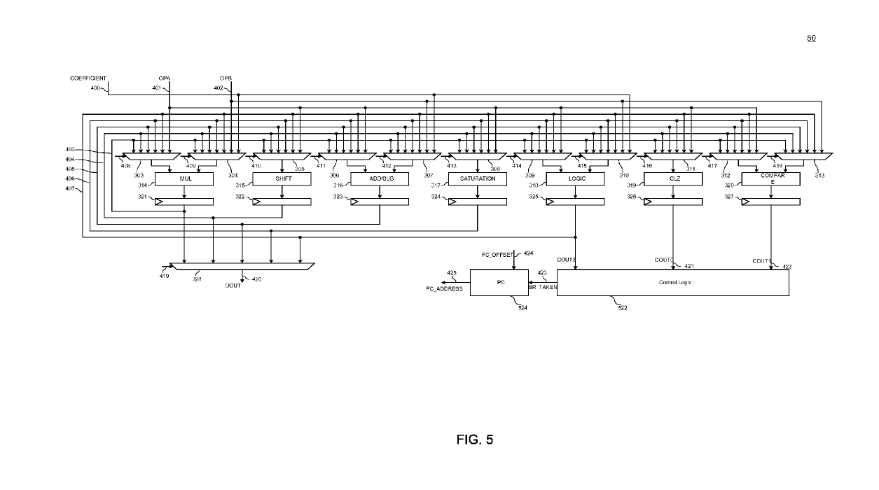

In addition to being coupled to the register file of a CPU, the disclosed ALU may also be coupled to other components of the CPU. FIG. 5 illustrates an exemplary ALU 50 coupled to other CPU components consistent with the disclosed embodiments. As shown in FIG. 5, ALU 50 is similar to ALU 20 in FIG. 2 and, further, ALU 50 is coupled to a control logic 522, which is also coupled to a program counter (PC) 524 of the CPU. When the input data to the functional blocks come from other resources besides the register file, the functional blocks 314, 315, 316 and 317 may be configured to form other data processing unit or units. For example, the functional blocks 319 and 320 are configured to generate control signals, while the logic unit 318 may be configured for either data processing operation or control generation. Thus, different modules (e.g., two processing modules for data and control) may be configured and operate in parallel.

Further, the generated control signals may be used to control series of operations of the functional blocks, including initiating, terminating, controlling pipeline of, and functionally reconfiguring, etc. For example, the functional blocks 318, 319 and 320 may be reconfigured to generate control signals in parallel to the operations of functional blocks 314-317. If a logic operation or comparison operation of input data to functional blocks 318, 319 and 320 triggers a certain condition of control logic 522, a control signal 423 is generated by control logic, and addressing space may be recalculated.

As shown in FIG. 5, control signal 423 may include a branch decision signal (BR_TAKEN), control signal 424 may include a PC offset signal (PC_OFFSET), and both control signals 423 and 424 may be provided to PC 524 such that a control signal 425 may be generated by PC 524 to include an address for next instruction (PC_ADDRESS). For example, if there are two operation sequences and one sequence may be executed depending on the result of the branch decision signal, a switch between the two sequences may be achieved using the control signals (e.g., 423, 424, and/or 425). Further, counters controlled by instructions may be provided to set a number for a program loop of one or more instructions to be repeated. The counters can be set by the instructions to specify the number of loops, and can be counted down or up. Thus, the number of repeated instructions (i.e.: the number of operations in the sequence) may be reduced.

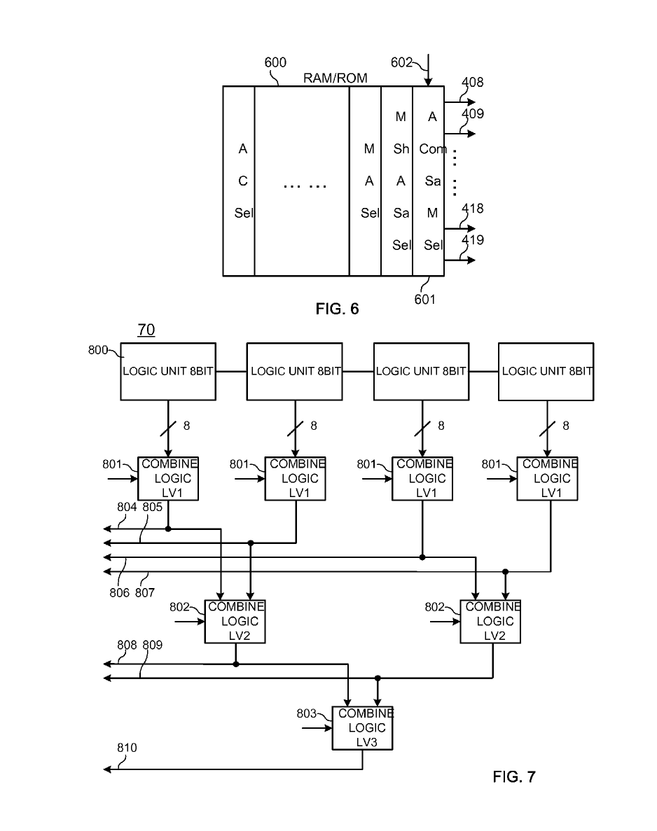

Because the various functional blocks in a reconfigurable ALU or CPU core may be configured to implement various operations, configuration information may be used to define and control such implementation. Control logic 522 may control the pipeline operation and data stream to avoid conflicts among data and resources and to enable a reconfiguration of a next operation mode or state, based on such configuration information. FIG. 6 illustrates an exemplary storage unit 600 storing configuration information consistent with the disclosed embodiments.

As shown FIG. 6, the storage unit 600 may include a read-only-memory (ROM) array, or a random-access-memory (RAM) array. Configuration information for various configurations of functional blocks of the ALU 20 (or ALU 50) may be stored in storage unit 600 by the CPU manufacturer such that a user may use the configuration information. The configuration information may include any appropriate type of information on configuring the various components of the ALU or CPU core to carry out the particular corresponding operation sequence. For example, configuration information may include control parameters for various operation sequences. A set of control parameters may define a sequence and a relationship of each functional block during condense operations. The control parameters corresponding to a particular operation sequence is pre-defined and stored in storage unit 600 which can be indexed by a decoded instruction or an inputted address, or indexed by writing to a register. The CPU manufacturer or the user may also update the configuration information for upgrades or new functionalities. Further, the user may define additional configuration information in the RAM to implement new operations sequences.

For example, as shown in FIG. 6, storage unit 600 may include various entries arranged in various columns. Column 601 may contain information for a particular configuration (a particular set of control parameters) including adding (A), comparison (Com), saturation operation (Sa), multiplication (M), and selection for output (Sel) for consecutive operations. To initiate such series of operations, a signal 602 generated from an instruction op-code may be used to index the memory entry or column 601 (e.g., using the op-code or the op-code plus a address field to address an entry/column). The control information or control parameters may be subsequently read out from the memory column 601 to form various control signals used to configure the ALU. These control signals may include control signals 408, 409, 410, 411, 412, 413, 414, 415, 416, 417, 418, and 419 in FIGS. 3&4, which are used to configure the functional blocks to form a specific local-pipeline corresponding to a specific operational state. Various functional modules may be formed based on the different control parameters in the storage unit 600, and each functional module may correspond to a specific set of control parameters.

Further, to support new instructions corresponding to the operation sequences, the reconfigurable CPU core or ALU may include instruction decoders (not shown) used to decode the input instructions and generate reconfiguration controls for the various functional blocks to carry out the series of operations defined by the control parameters. That is, a decoded instruction may contain a storage address which may index storage unit 600 to output configuration information which can be used to generate control signals to control the various multiplexers and other interconnecting devices. Alternatively, the decoded instruction may contain configuration parameters which can be used to generate control signals or used directly as the control signals to control the various multiplexers and other interconnecting device (i.e., reconfiguration controls). Because the functional blocks are configured by these reconfiguration controls, the configuration information defines a particular inter-connection relationship among the functional blocks. The input instructions are compatible with the reconfigurable CPU core, and may be used to configure the reconfigurable CPU core to function as a conventional CPU for compatibility (e.g., software compatibility).

For example, the input instructions may be decoded to address the storage unit 600 to generate reconfiguration controls used by the multiplexers to select specific inputs, or used for both simple operations, e.g., addition, multiplication and comparison, and a sequence of operations, e.g., multiplication followed by addition, saturation processing, bit shifting or addition followed by comparison and add-compare-select (ACS). In some embodiments, certain operations are repeated, and counters may be provided to count the number of repetitive cycles. Alternatively, storage unit 600 can also be controlled by a control logic (e.g., control logic 522 in FIG. 5) based on whether a particular condition has been met.

The inter-connections and the corresponding functional blocks are configured to implement a particular functionality (or a particular sequence of operations). The configuration parameters can then be used to generate corresponding control signals, which may remain unchanged for a certain period of time. Thus, the interconnected functional blocks can repeat the particular operation over and over and become a functional module with a particular functionality.

To generate the various control signals, certain functional blocks in the ALU may be improved to have more arithmetic or logic functionalities, and certain new functional blocks may be defined in the ALU. FIG. 7 illustrates an exemplary logic unit with expanded functionalities. The logic unit 318 in the ALU 20 (FIG. 2) may be configured to implement more functions in different applications.

As shown in FIG. 7, logic unit 318 may include a 32-bit logic unit 800. The 32-bit logic unit 800 may be divided into four 8-bit logic units, and each 8-bit logic unit may process an 8-bit byte. Thus, four 8-bit logic units respectively output four signals of one byte, i.e., 8 bits, which are further processed by four combine logic LV1 801. Four one-bit output signals 804, 805, 806, and 807 are generated by the four combine logic LV1 801, corresponding to individual bytes in the 32-bit word.

Further, the output signals 804 and 805 are processed by one combine logic LV2 802 to generate an output control signal 808, and the signals 806 and 807 are also processed by another combine logic LV2 802 to generate another output control signal 809. The control signals 808 and 809 correspond to two individual half-words in the 32-bit word. At the same time, the output signals 809 and 809 are processed by a combine logic LV3 803 to generate an output control signal 810 corresponding to the one-word (32-bit) input. Because the control signals 804, 805, 806, 807, 808, 809, and 810 may be separately used in various operations as control signals, more degrees of control may be implemented. Further, the various combine logic unit LV1 801, LV2 802, and LV3 803 are reconfigurable according to specific applications.

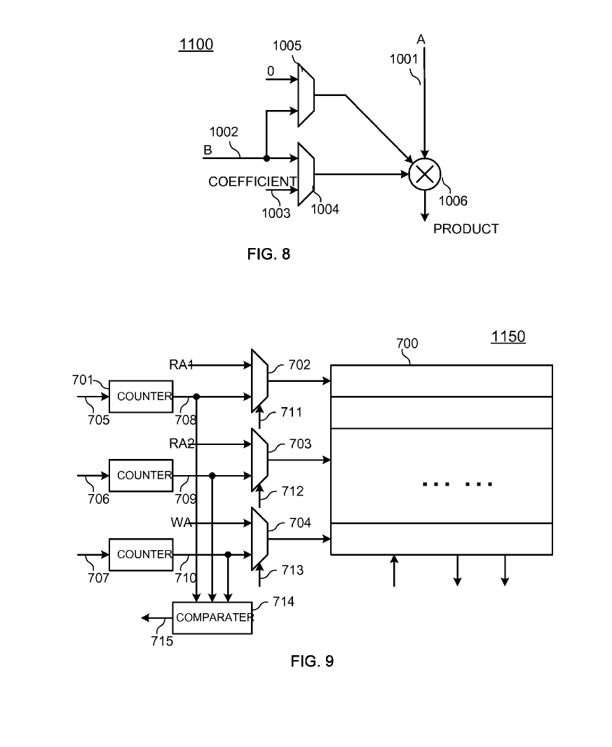

FIG. 8 illustrates an exemplary three input multiplier 1100 in the ALU consistent with the disclosed embodiments. A typical multiplier implements a multiply-add/subtract operation of three input signals A, B and C to obtain a result for B±A×C by adding two pseudo-summing data obtained from consecutive compression of a partial product. As shown in FIG. 8, a multiplier unit 1006 is a multiplier implementing both multiplication and addition, with two input signals (A, B). A first signal 1001 and a second signal output of multiplexer 1004 are processed by the multiplier/accumulator 1006 as multiplier and multiplicand, and a third signal output of multiplexer 1005 is used as an adder input signal for multiplier/accumulator 1006. In operation, the first signal 1001 remains as the first input to the multiplier unit 1006, while a multiplexer 1004 is provided to select one of the second signal 1002 and the third signal 1003 as the second input to the multiplier 1006. A multiplexer 1005 is further provided to select one of the second signal 1002 and “0” as the third input to the multiplier unit 1006. Thus, common operations of multiplication A*B, or A*COEFFICIENT±B may be implemented.

FIG. 9 illustrates an exemplary first-in-first-out (FIFO) buffer consistent with the disclosed embodiments. In certain embodiments, part or all of register file (RF) may be unused by the functional blocks as a normal register file. On the other hand, there may be a need for a FIFO to buffer result from one functional block to another or from one CPU core to another. As shown in FIG. 9, FIFO buffer 1150 which includes a group of registers 700. One or more FIFOs may be formed by integrating and configuring part of the functional blocks with part or the all of the register file. Counters (e.g., 701) may be formed by configuring unused adders from the ALU. The counters are coupled to receive control signals 705, 706 and 707, and generate read pointers 708 and 709, and write pointer 710, respectively, to address the FIFO. A comparator 714, itself may be a functional block re-configured from an existing functional block, is coupled to receive the outputs 708, 709 and 710, and generate a comparison result 715 which may be further used to generate counter control signals. Further, the multiplexers 702, 703, and 704 select among the register file read address RA1, read address RA2, register file write address WA and the FIFO read pointers 708 and 709, and FIFO write pointer 710, according to the controls 711, 712, and 713, respectively.

More particularly, inputs 705, 706 and 707 to counters 701 may be set up to increase the read pointers and write pointer value to the FIFO 1150 after corresponding read and write actions. Comparator 714 may be used to generate signals 715 for detecting and/or controlling the FIFO operation state. For example, a read pointer value being increased to equal the write pointer value indicates a FIFO 1150 empty, and a write pointer value being increased to equal with the read pointer value indicates a FIFO full. Other configurations may also be used. If an ALU does not contain all the components required for the FIFO 1150, components from other ALUs or ALUs from other CPU cores may be used, as explained in later sections. Memory such as data cache can also be used to form FIFO buffers. Further, one or more stacks can be formed from register file or memory by using similar method.

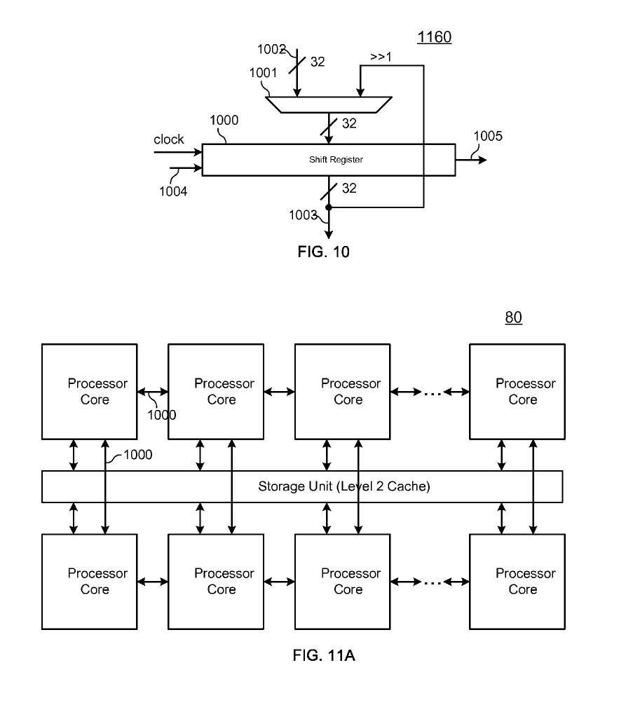

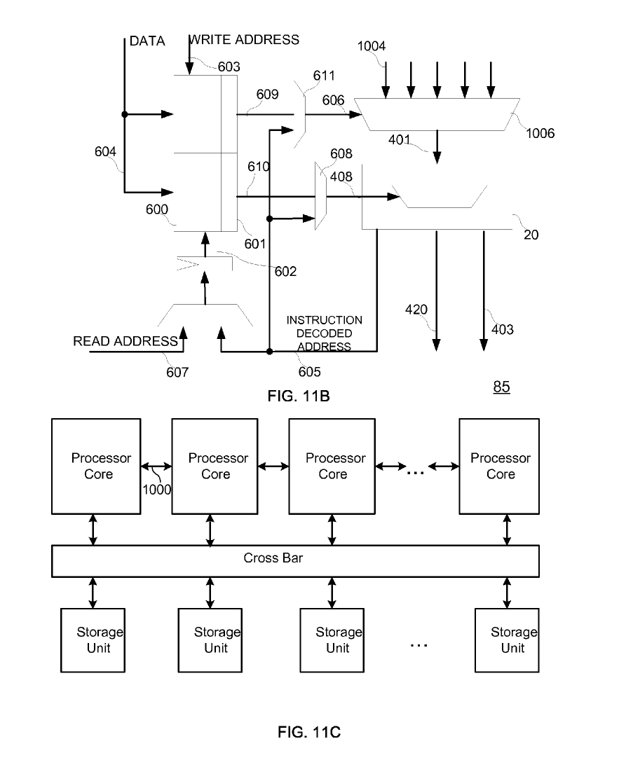

FIG. 10 illustrates an exemplary serial/parallel data convertor 1160 by configuring a shift register driven by a clock signal. As shown in FIG. 10, a shift register 2000 is provided as a basic operation unit. A multiplexer 2001 is coupled to shift register 2000 select one input from a 32-bit parallel signal 2002 and the output 32-bit parallel signal 2003 from the shift register 2000. The signal 2002 may be selected, and shifted by one bit in the shift register 2000 to generate the signal 2003. The signal 2003 may be selected as the input to the shifter register 2000 for further bit shifting. Therefore, bit shifting operation is implemented.

The shifter register 2000 is also coupled to receive a clock and a one-bit signal 2004. In serial-to-parallel data conversion, the serial data are inputted from the one-bit signal 2004 and converted to the 32-bit parallel signal 2003 (shifted by 1 bit) under the control of the clock. In parallel-to-serial data conversion, the 32-bit parallel signal 2002 is converted to a serial signal 2005. Therefore, serial and parallel data are converted by the shifter register 2000.

In addition, certain basic CPU operations may also be performed using available functional blocks, such as functional blocks in FIG. 2. For example, the operation of loading data (LOAD operation) may use the adder/subtractor functional block (316 in FIG. 2). Loading data involving generating a load address and putting the generated load address on an address bus to the data memory. The load address is typically generated by adding the content of a base register (the base address) with an offset address. Therefore, the LOAD operation can be performed, for example, by configuring the multiplexer 306 to select a base address (for example, from OPA 401) and configuring the multiplexer 307 to select an offset address (for example, from OPB 402) as the two operands to adder 316. The adder result (the sum) may then be stored in register 323. Multiplexer 328 is then configured to select output of register 323 (bus 405) and output it to DOUT bus 420 to be sent to the data memory as memory address. Alternatively, bus 405 may also be sent to data memory as memory address.

The above disclosed examples illustrate pipeline configurations for functional blocks in a same ALU or processor/CPU core. However, ALUs from different CPU cores or other components from different CPU cores may also be configured to form various pipelined or similar structures. FIG. 11A illustrates an exemplary block diagram of a multi-core structure 80 consistent with the disclosed embodiments.

As shown in FIG. 11A, a plurality of processor cores are arranged to share one or more storage unit (e.g., level 2 cache). In addition, one or several functional blocks in adjacent processor cores may be configured for direct connection using one or several buses 1000. That is, the plurality of processor cores may be interconnected using different interface modules such as the storage unit and direct bus connectors. While all processor cores may be coupled through the storage unit, adjacent processor cores can also be directly connected through bus connectors 1000. Thus, data flow in the directly-connected units can be exchanged directly among the processing units without passing through the storage units. The scale and functionality of coupled processor cores may thus be enhanced.

In particular, bus lines 1000 may be arranged in both horizontal and vertical directions to connect any number of processing units or processor cores. Bus lines 1000 may include any appropriate type of data and/or control connections. For example, bus lines 1000 may include data bypasses (e.g., buses 403-407 in FIG. 2), inputs and outputs (e.g., 400, 401, 402, and 420 in FIG. 2), and control signals (e.g., 408-419 in FIG. 2), etc. Other types of buses may also be included. That is, bus lines 1000 may be used to inter-connect different functional blocks in different processor cores such that one or more functional modules may be formed across the different processor cores. Thus, a functional module may be formed within a single processor core by interconnecting functional blocks within the single processor core, or formed across different processor cores via bus lines 1000.

When forming functional modules across different processor cores, bus lines 1000 may also enable the functional modules to perform particular operation sequences without going through shared memory mechanism, instead using direct connection to ensure speed and throughput of the multi-core functional modules. Further, control parameters defining the operation sequences for multi-core functional modules may be stored locally or in shared memory to be accessible to all participating processor cores. Any single processor core may perform an operation sequence as if it is local.

FIG. 11B illustrates an exemplary inter-connection across different processor cores using previously described components and configurations. As shown in FIG. 11B, a multiplexer 1006 is configured to select a plurality of inputs 1004 from different processor cores (e.g., outputs from functional modules or data from pipeline registers) under control signal 606. Output from multiplexer 1006 may be selectively connected to any input lines of functional module 20 (e.g., OPA 401 in FIG. 2). Functional module 20 may also generate outputs 420 and 403. Further, storage unit 600 may contain configuration information to control inter-connections among functional blocks within a processor core, intra-processor configuration information, or functional blocks (or functional modules) across different processor cores, inter-processor configuration information. Optionally, intra-processor configuration information and inter-processor information may be stored in separate locations in storage unit 600 (e.g., an upper half and a lower half).

Decoded instruction 605 may contain an address which is used to address storage 600. It may also contain configuration parameters which can be used to generate control signals. Address 603 may be used as a write address to write control information or data 604 into storage unit 600. Further, read address 602 may be from two sources: a storage address in decoded instruction 605 or a read address 607 inputted externally. Read address 602 may select either of the two address sources through a multiplexer. Multiplexer 611 selects source of inter-connection control signals 606 from output of storage unit 609 and decoded instruction 605. Multiplexer 608 selects source of ALU control signals 408 from output of storage unit 610 and decoded instruction 605.

When multiplexer 611 and 608 select decoded instruction 605, a particular set of control signals may be generated based on the set of control parameters in decoded instruction 605 corresponding to a particular instruction. The control signals may include control signals used within the single processor core (e.g., control signal 408 for a multiplexer in functional module 20) and also control signals used with different processor cores (e.g., control signal 606 to select inputs from outputs of different processor cores).

On the other hand, when multiplexer 611 and 608 selects storage unit outputs 609 and 610, based on read address 602, a particular set of control parameters may be read out from the configuration information storage 601 of storage unit 600, and control signals may be generated based on the set of control parameters corresponding to a particular operation sequence. The control signals may include control signals used within the single processor core and also control signals used across different processor cores.

FIG. 11C illustrates an exemplary block diagram of another multi-core structure 85 consistent with the disclosed embodiments. Multi-core structure 85 is similar to multi-core structure 80 as described in FIG. 11A. However, multi-core structure 85 uses a cross-bar switch to interconnect the plurality of processor cores, in addition to using bus lines 1000 to adjacent processor cores. Other configurations may also be use.

The inter-connected multi-core structures can connect different functional modules with corresponding functionalities, and may exchange data among the different functional modules to realize a system-on-chip (SOC) configuration. For example, some CPU cores may provide control functionalities (i.e., control processors), while some other CPU cores may provide operation functionalities and act as functional modules. Further, the control processors and the functional modules exchange data based on any or all of shared memory (e.g., a storage unit), direct connection (bus), or cross-bar switches, such that the SOC configuration is achieved.

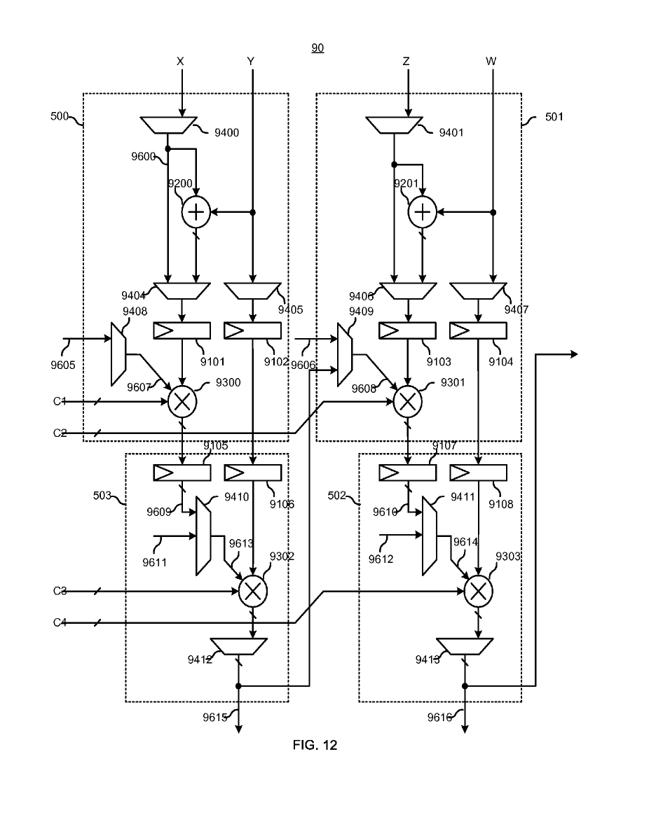

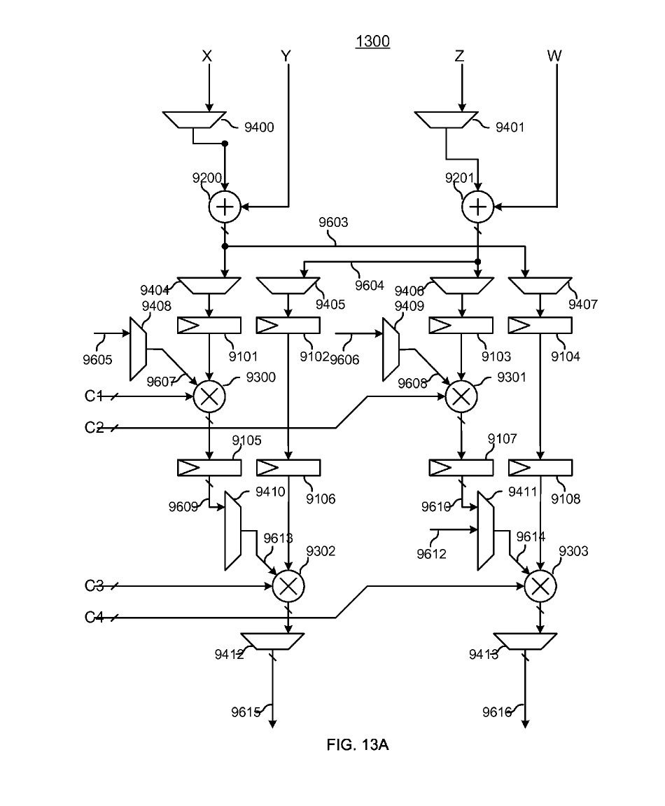

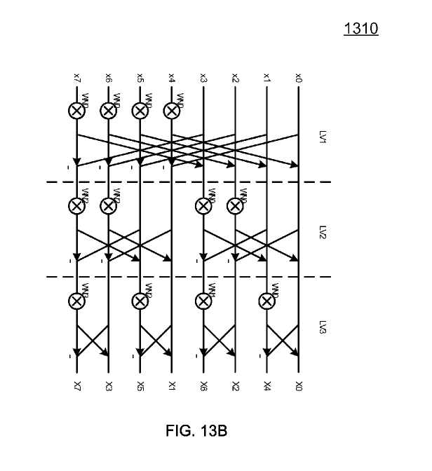

Further, the interconnected multi-core structures may be configured to implement series of operations for particular applications by configuring ALUs in multiple processor cores. FIG. 12 illustrates an exemplary multi-core structure 90 consistent with the disclosed embodiments. As shown in FIG. 12, functional modules 500, 501, 502 and 503 are located in separate processor cores (as shown in dotted rectangles). As previously explained, each functional module 500, 501, 502, or 503 may contain a plurality of functional blocks and may be configured to implement a series of operations. Assuming each one of these functional modules 500, 501, 502, and 503 may be found in any processor core interconnected, structure 90 may be created from the functional modules 500, 501, 502 and 503 by configuring any respective processor cores. Similar to single core configuration as described in FIG. 6, inter-connection among multiple processor cores may also be controlled by configuration information. The configuration information may also be used to provide controls to inter-connecting devices across the multiple processor cores, including multiplexers, pipeline registers, and bus lines 1000. Other functional modules may also be used as the inter-connecting devices. For example, a FIFO buffer (e.g., FIFO buffer 1150 in FIG. 9) comprising register files from one or more processor cores or a FIFO memory may be used to inter-connect the processor cores. In addition, control parameters stored in a storage unit may be used to control the inter-connecting devices corresponding to a particular operation sequence by functional blocks across different processor cores.

For example, functional module 500 may include inputs X, Y, C1, and 9605, multiplexers 9400, 9404, 9405, and 9408, pipeline registers 9101 and 9102, adder 9200, and multiplier 9300. Functional module 500 may implement an addition and a multiplication-and-accumulation (MAC) operation.

Functional module 503 may include input C3, multiplexers 9410 and 9412, pipeline registers 9105 and 9106, and multiplier 9302. Functional module 503 may implement an additional multiplication-and-accumulation (MAC) operation. Further, functional module 500 and functional module 503 may be coupled to form a new functional module (500+503) to generate an output 9615.

Further, functional module 501 may include inputs Z, W, C2, and 9606, multiplexers 9401, 9406, 9407, and 9409, pipeline registers 9103 and 9104, adder 9201, and multiplier 9301. Functional module 501 may also implement an addition and a multiplication-and-accumulation (MAC) operation.

Functional module 502 may include input C4, multiplexers 9411 and 9413, pipeline registers 9107 and 9108, and multiplier 9303. Functional module 502 may implement an additional multiplication-and-accumulation (MAC) operation. Further, functional module 501 and functional module 502 may be coupled to form a new functional module (501+502) to generate an output 9616. In addition, the new functional modules may form structure 90, which may also be considered as a new functional module, and a plurality of structures 90 may be further interconnected to form extended functional module from additional CPU cores. Further, although functional modules 500, 501, 502, and 503 are described to be implemented in different processor cores, a same processor core may also be able to implement two or more functional modules of functional modules 500, 501, 502, and 503. For example, functional modules 500 and 503 may be implemented in a single processor core, while functional modules 501 and 502 may be implemented in another single processor core.

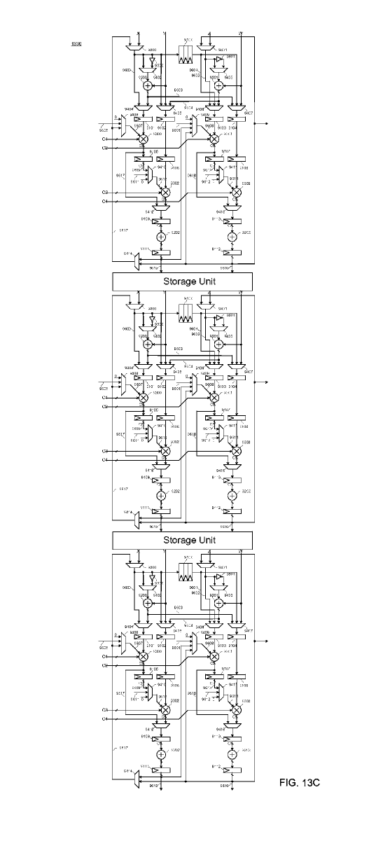

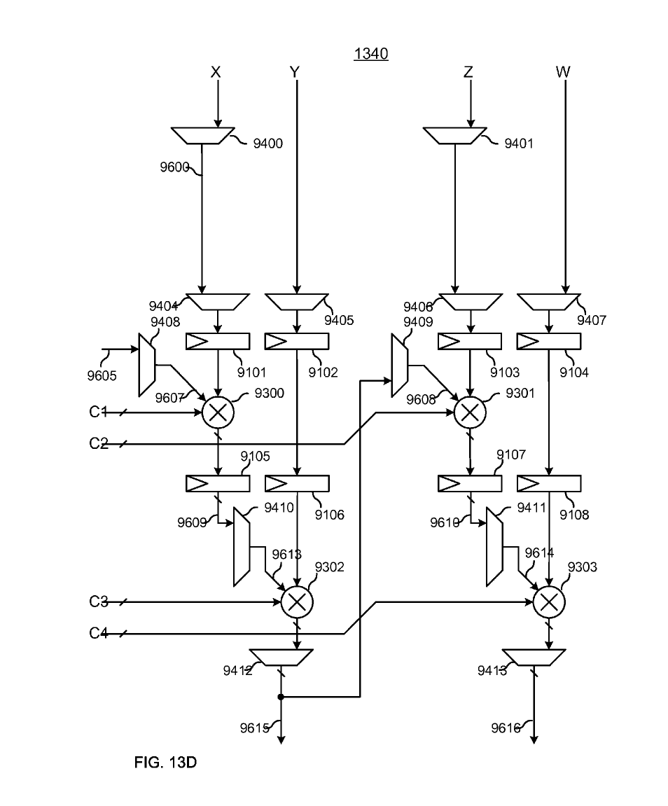

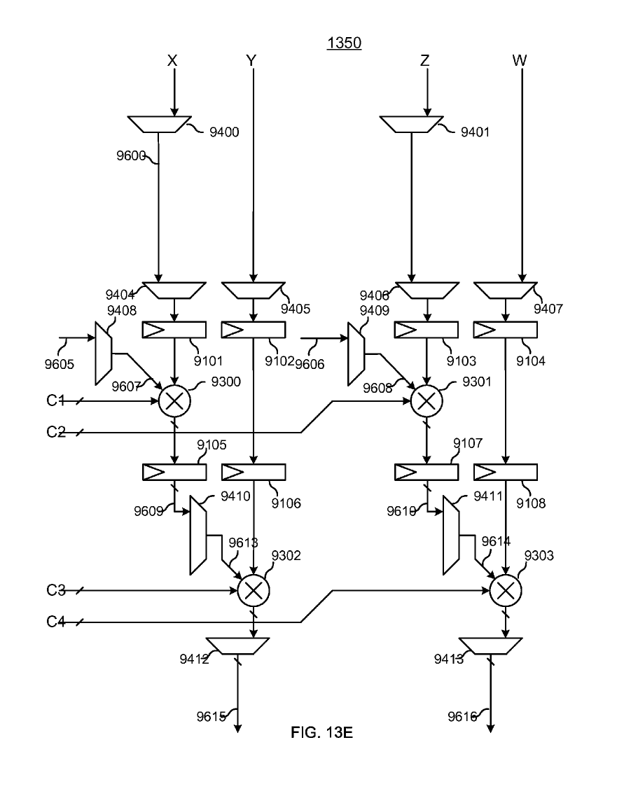

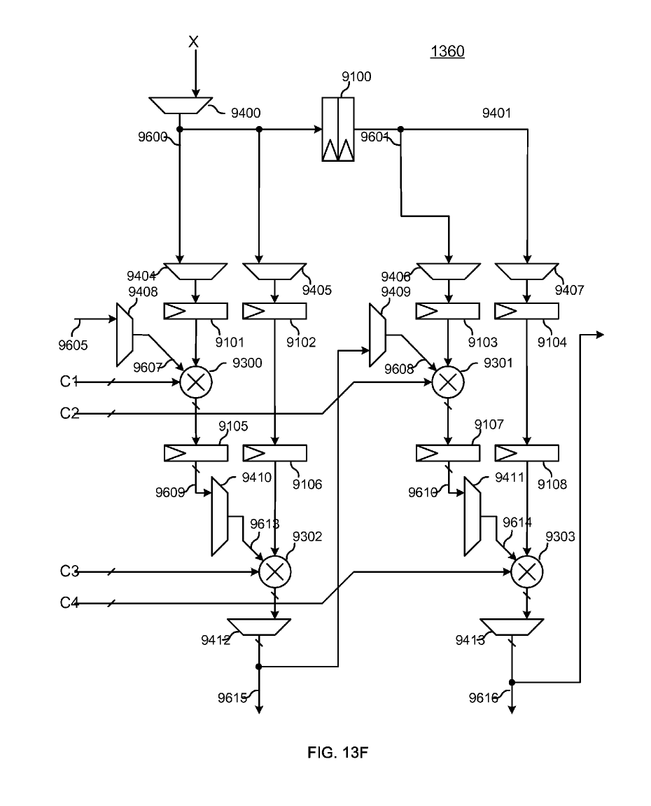

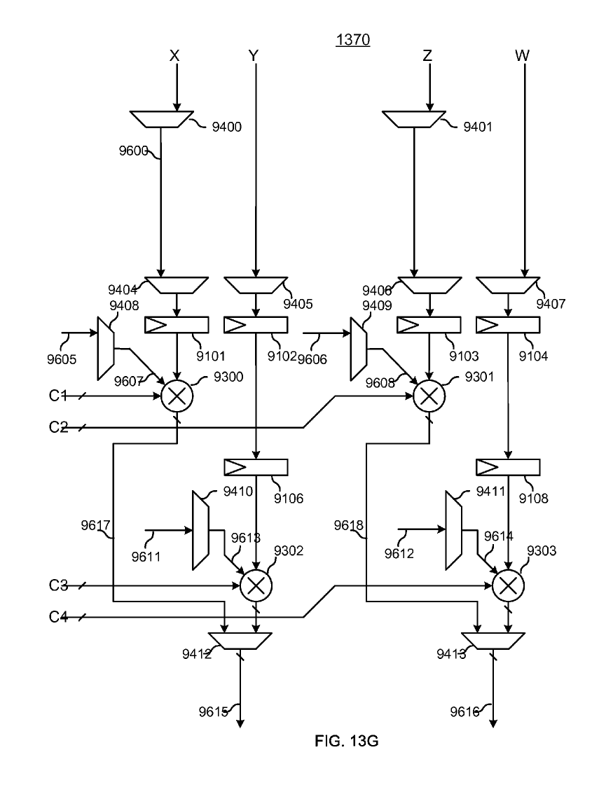

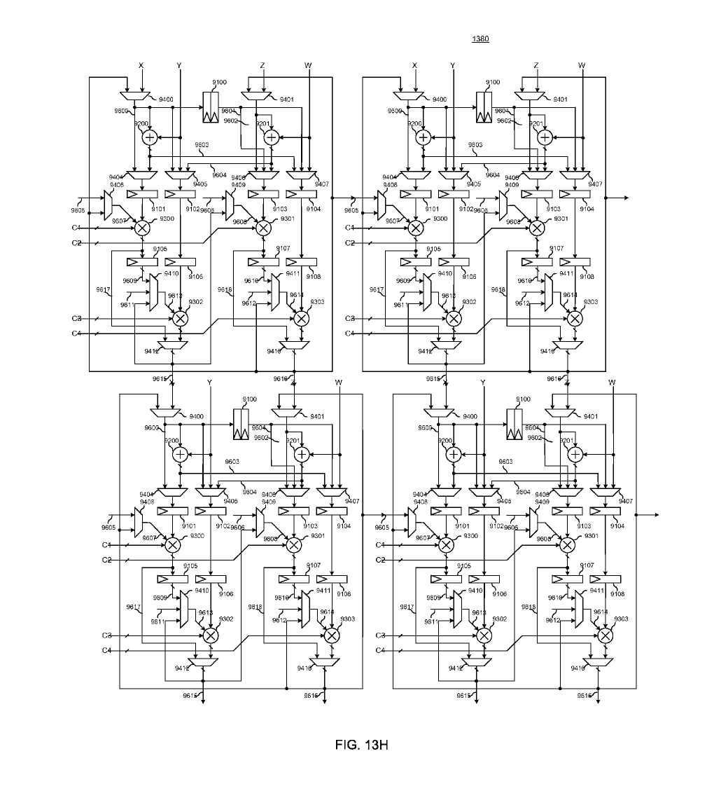

As explained in sections below (e.g., FIG. 13A), functional blocks 500, 501, 502 and 503 may be configured to implement a Fast Fourier Transfer (FFT) application and, more particularly, a complex FFT butterfly calculation for the FFT application. In addition to FFT, other DSP operations, such as (finite impulse response) FIR operations, and array multiplication, may be implemented in a similar manner due to their similar demand on bandwidth and rate.

FIG. 13A illustrates an exemplary multi-core structure 1300 configured for a complex FFT butterfly calculation. A butterfly calculation includes a multiplication and two additions/subtractions, and all involved data are complex numbers including real and imaginary parts which are processed separately in each operation. Hence, the butterfly calculation is represented as below:

A′=A+BW=Re(A)+Re(BW)+j[Im(A)+Im(BW)] (1)

B′=A−BW=Re(A)−Re(BW)+j[Im(A)−Im(BW)] (2)

Re(A′)=Re(A)+[Re(B)Re(W)−Im(B)Im(W)] (3)

Im(A′)=Im(A′)+[Re(B)Im(W)+Im(B)Re(W)] (4)

Re(B′)=Re(A)−[Re(B)Re(W)−Im(B)Im(W)] (5)

Im(B)=Im(A′)−[Re(B)Im(W)+Im(B)Re(W)] (6)

where A, B and W three input complex numbers, and A′ and B′ are two output complex numbers.

Thus, as shown in equations (3), (4), (5) and (6), the butterfly calculation involves four additions, four subtractions and four multiplications. More particularly, the four multiplications are Re(B)Re(W), Im(B)Im(W), Re(B)Im(W), and Im(B)Re(W), respectively. In certain embodiments, four stages of operations may be pipelined, and pipeline registers 9101-9108 are employed to store intermediate signals between pipeline stages. The data 9603 and 9604 correspond to Re(B) and Im(B), respectively, and selected by multiplexers 9404, 9405, 9406, and 9407 controlled by signals generated from specific logic operation. The input signals C1 and C2 are both equal to Re(W), and C3 and C4 are equal to −Im(W) and Im(W), respectively.

The signals selected by the multiplexers 9604, 9605, 9606, and 9607 are used as the inputs 9607, 9608, 9609, and 9610 to the addition operation within the multipliers 9300, 9301, 9302, and 9303. The inputs 9607 and 9608 are equal to 0, and the inputs 9609 and 9610 are retrieved from the pipeline registers 9105 and 9107 which are signals generated by prior multiplications in 9300 and 9301, respectively. As a result, the four multipliers 9300, 9301, 9302, and 9303 are used to implement the operations of 0+Re(B)Re(W), 0+Im(B)Re(W), [Re(B)Re(W)]−Im(B)Im(W), and [Im(B)Re(W)]+Re(B)Re(W), respectively. Hence, two data selected by the multiplexers 9412 and 9413 are equal to Re(B)Re(W)−Im(B)Im(W) and Re(B)Im(W)+Im(B)Re(W), i.e., the cross-products of B and W in equations (3), (4), (5) and (6). The adders in the multipliers 9302 and 9303 add up two cross-products to output signals 9615 and 9616 associated with Re(BW) and Im(BW), respectively. The output signals 9615 and 9616 may be used as the input signals X and Z, in a subsequent stage of FFT butterfly operation or in the same stage as feedback. The other two inputs Y and Z are equal to Re(A) and Im(A), respectively, in equations (3), (4), (5), and (6).

A 2ⁿ-point FFT normally includes n×2ⁿ⁻¹ butterfly FFT operations. The FFT may be implemented either by connecting n×2ⁿ⁻¹ butterfly calculations in a specific order, or by using n butterfly calculations where storage units are needed between the calculation stages. FIG. 13B illustrates an exemplary structure 1310 of a 2³-point, i.e., eight-point, FFT using twelve butterfly calculations. Three stages of operations are needed, and each stage includes four butterfly calculations. Hence, twelve, i.e., 3×2³⁻¹, butterfly calculations are used. In this embodiment, twelve butterfly calculations are interlinked as in FIG. 13B.

As shown in FIG. 13B, four functional modules (structure 90 in FIG. 13A) WN0 are used in LV1 stage, four functional modules (two WN0 and two WN2) are used in LV2 stage, and four functional modules (WN0, WN1, WN2, and WN3) are used in LV3 stage to implement the 8 point FFT, and x0-x7 are inputs. Each set of four functional modules has to be used 4 times per FFT operation. The configuration within the CPU core may stay the same, but the input sources (operands from memory) may be changed according to certain software programs including the operation sequences as explained previously. The control parameters defining the operation sequences may also be stored in certain storage unit and the operation results may also be stored in certain storage unit.

FIG. 13C illustrates another exemplary structure 1330 of a 2³-point, i.e., eight-point, FFT using three butterfly calculation functional modules as shown in FIG. 13A. The structure 1330 include three butterfly calculation modules which are connected using two storage units, e.g., RAM. Each butterfly calculation stage implements four consecutive butterfly calculations as explained in FIG. 13A. The results from the first or second butterfly calculation functional module or stage are stored in the subsequent storage unit, and the next butterfly calculation module or stage may retrieve the result for later operations. Specific controls are applied to identify an appropriate data pipeline among three butterfly calculation modules or stages to complete the eight-point FFT. In certain embodiments, one butterfly calculation is sufficient to implement the eight-point FFT.

FIG. 13D illustrates an exemplary structure 1340 for implementing operations for calculating summations of products by configuring ALUs from multiple processor cores. These operations may be used in discrete cosine transform (DCT), distributed hash table (DHT), vector multiplication, and image processing, etc. The operations generally involving calculating an equation as

y(n)=Σ coeff(i)x(i) (7)

where i is an index (integer), coeff(i) are coefficients, x(i) are input data series and y is a sum of n products. The coefficients coeff(i) may be constant for a specific period during operation. For example, a DHT conversion may be represented as

$$\begin{matrix}[ Math . 1 ] & \\ X ( k ) = {\sum }_{n = 0}^{N - 1} x ( n ) [ cos \frac{2 π kn}{N} + sin \frac{2 π kn}{N} ] & ( 8 )\end{matrix}$$

where k=0, . . . , N−1. If N is specified, the results of

$$[ Math . 2 ]$$

$$cos \frac{2 π kn}{N} + sin \frac{2 π kn}{N}$$

can be determined and can be used as coefficients in equation (7). Therefore, DHT may be implemented as a series of sum-of-products operations.

As shown in FIG. 13D, a four-stage multiply-and-accumulate (MAC) operation is formed when the output 9615 from the first two-stage operations is used as an input to the multiplexer 9409 in the second two-stage operation. Similarly, this operation may be expanded to more stages as needed by interconnecting more processor cores to form a pipeline operation with a desired length. After the pipeline operation, the output from the last module or processor core (9515 or 9516) is the output of the entire sum-of-products operation.

Further, the inputs X, Y, Z and W are equal to x(n) in equation (7), where the respective index n is of consecutive values, and the pipeline operation is controlled by software programs. The coefficient inputs C1, C3, C2 and C4 are multiplied by X, Y, Z and W by multipliers 9300, 9302, 9301, and 9303, respectively, and therefore, the associated coefficient indexes are consistent. The products 9613, 9608, and 9614 are selected by the multiplexers 9410, 9409, and 9411, respectively, for consecutive sum-of-products operations. If there is any additional pipelined stages in front of structure 1340, a previous product 9607 may be selected by the multiplexer 9408 for consecutive sum-of-products operations. These operations are also applicable to DCT, vector multiplication, and matrix multiplication. The matrix multiplication is derived from vector multiplication, and the matrix multiplication can be separated into a plurality of vector multiplications.

FIG. 13E illustrates an exemplary structure 1350 of implementing a two dimension (2D) matrix multiplication by configuring ALUs from multiple processor cores. Products of vector multiplication are calculated by configuring the ALUs to connect a series of functional modules horizontally such that each operation of the functional modules can be used as an element in the product matrix from a higher-dimension matrix multiplication.

For example, a 2D product matrix of two matrixes may be represented as

$$\begin{matrix} [ Math . 3 ] & \\ [ \begin{matrix}a 00 & a 01 \\ a 10 & a 11\end{matrix} ] \cdot [ \begin{matrix}c 00 & c 01 \\ c 10 & c 11\end{matrix} ] = [ \begin{matrix}a 00 c 00 + a 01 c 10 & a 00 c 01 + a 01 c 11 \\ a 10 c 00 + a 11 c 10 & a 10 c 01 + a 11 c 11\end{matrix} ] & ( 9 )\end{matrix}$$

The basic multiply-accumulate unit includes four multipliers, and therefore, two matrix elements, one vector, may be output during each clock cycle. The inputs C0, C1, C2 and C3 correspond to c00, c01, c10 and c11, respectively. During the first cycle, the inputs X and Z correspond to a00, and are selected by 9404 and 9406, and are further stored in 9101 and 9103, respectively. The inputs Y and W correspond to a01, and are selected by 9405 and 9407, and are further stored in 9102 and 9104, respectively. During the second cycle, the multipliers 9300 and 9301 generate two products 0+a00c00 and 0+a00c01 (a vector). At the same time, the inputs X and Z correspond to a10, and the inputs Y and W correspond to all. Further, the multipliers 9302 and 9303 generate two products a01c10 and a01c11, respectively. During the third cycle, adders in multiplier 9302 and 9303 generate tow sums of products a00c00+a01c10 and a00c01+a01c11 on outputs 9615 and 9616, respectively, while the multipliers 9300 and 9301 starts operation for a next vector input. Thus, after the third cycle, the first vector in the product of equation (9) is obtained, and the second vector also starts to be processed. Therefore, vectors are generated in consecutive cycles to form a data stream and operation efficiency may be significantly increased.

FIG. 13F illustrates an exemplary structure 1360 for implementing an FIR operation by configuring ALUs from multiple processor cores. An FIR operation involves a convolution operation, as commonly applied in DSP applications, and may be implemented as one type of consecutive multiply-and-accumulate operation. The FIR operation may be described as:

$$\begin{matrix}[ Math . 4 ] & \\ y ( n ) = {\sum }_{k = 0}^{N - 1} h ( k ) x ( n - k ) & ( 10 )\end{matrix}$$

where N is the FIR order, k and n are integers, and h(k) are coefficients. If the FIR order N is specified, the coefficients vector h(k) can be determined as well. The index of the input vector x(i), i=n−k, is in a reverse order with respect to h(k).

The input vector x(i) is provided on the input X for the convolution operation. Consecutive registers 9100 may include two or more registers connected back-to-back to control timing for data of the input vector x(i) to reach the multipliers 9301 and 9303 at proper time for operation. Because the convolution operation is also based on multiply-and-accumulate operations, other configurations of structure 1360 may be similar to other examples explained previously. Further, multiple structures 1360 may be provided based on the order of the FIR. As similarly, when connecting more structures 1360, output of one structure 1360 (e.g., output 9616) may be connected to input of another structure 1360 (e.g., input 9605) such that a total number of connected structures is determined by the FIR order N. The output of the FIR operation is the signal 9615 or 9616.

FIG. 13G illustrates an exemplary structure 1370 for implementing a matrix transformation operation by configuring ALUs from multiple processor cores. Matrix transformation is widely applied in image processing, and includes shifting, scaling and rotation.

Matrix transformation may be treated as special matrix multiplication or vector multiplication, and the operations may be presented as

$$\begin{matrix}[ Math . 5 ] & \\ \begin{matrix}[ \begin{matrix}{x}^{′} & {y}^{′} & {z}^{′} & 1\end{matrix} ] = [ \begin{matrix}x & y & z & 1\end{matrix} ] \cdot [ \begin{matrix}1 & 0 & 0 & 0 \\ 0 & 1 & 0 & 0 \\ 0 & 0 & 1 & 0 \\ Tx & Ty & Tz & 1\end{matrix} ] \\ = [ \begin{matrix}x + Tx & y + Ty & z + Tz & 1\end{matrix} ]\end{matrix} & ( 11 ) \\ [ Math . 6 ] & \\ \begin{matrix}[ \begin{matrix}{x}^{′} & {y}^{′} & {z}^{′} & 1\end{matrix} ] = [ \begin{matrix}x & y & z & 1\end{matrix} ] \cdot [ \begin{matrix}Sx & 0 & 0 & 0 \\ 0 & Sy & 0 & 0 \\ 0 & 0 & Sz & 0 \\ 0 & 0 & 0 & 1\end{matrix} ] \\ = [ \begin{matrix}x \cdot Sx & y \cdot Sy & z \cdot Sz & 1\end{matrix} ]\end{matrix} & ( 12 ) \\ [ Math . 7 ] & \\ Rx = [ \begin{matrix}1 & 0 & 0 & 0 \\ 0 & cos θ & sin θ & 0 \\ 0 & - sin θ & cos θ & 0 \\ 0 & 0 & 0 & 1\end{matrix} ] & ( 13 ) \\ [ Math . 8 ] & \\ Ry = [ \begin{matrix}cos θ & 0 & - sin θ & 0 \\ 0 & 1 & 0 & 0 \\ sin θ & & cos θ & 0 \\ 0 & 0 & 0 & 1\end{matrix} ] & ( 14 ) \\ [ Math . 9 ] & \\ Rz = [ \begin{matrix}cos θ & sin θ & 0 & 0 \\ - sin θ & cos θ & 0 & 0 \\ 0 & 0 & 1 & 0 \\ 0 & 0 & 0 & 1\end{matrix} ] & ( 15 )\end{matrix}$$

With respect to equation (11), where the vector [x y z] is shifted to [x′ y′ z′] by a (Tx, Ty, Tz). The inputs X, Y, Z and W correspond to x, y, z and 1, respectively. The inputs C1, C2, C3 and C4 correspond to 1. The input signals 9607, 9608, 9613, and 9614 (operands) are selected by the multiplexers 9408, 9409, 9410 and 9411 corresponding to Tx, Ty, Tz and 0, respectively. Therefore, the outputs of the multipliers 9300, 9301, 9302 and 9303 correspond to x+Tx, y+Ty, z+Tz and 1, respectively. At the end of the first cycle, using data bypasses, the outputs 9617 and 9618 of the multipliers 9300 and 9301 may be selected for output using the multiplexers 9412 and 9413, while the outputs of the multipliers 9302 and 9303 are selected using the same multiplexers during the next cycle.

With respect to equation (12), where the vector [x y z] is scaled by a vector [Sx, Sy, Sz] to obtain the vector [x′ y′ z′], the aforementioned method for matrix shifting is applicable except that the inputs C1, C2, C3 and C4 correspond to Sx, Sy, Sz and 1, respectively, and the multiplexers 9408, 9409, 9410, and 9411 select output signals 9607, 9608, 9013, and 9614 to be 0. In addition, any operation with ‘1’ in the matrix may be implemented by controlling the data address in the memory storing operation data instead of relying on actual operations.

Further, with respect to equations (13), (14), and (15), matrix rotation is based on a rotation matrix, and the rotation matrixes for y-z, x-z and x-y rotations of an angle θ are represented in equations (13), (14), and (15), respectively. For example, for the y-z rotation, the aforementioned method for matrix shifting is also applicable. However, C1, C2, C3 and C4 now correspond to cosθ, −sinθ, sinθ, and cosθ; the inputs X and Y correspond to y; and the inputs Z and W correspond to z. The multiplexers 9408, 9409, 9410, and 9411 select output signals 9607, 9608, 9013, and 9614 to be 0. Similarly, using data bypasses, the outputs 9617 and 9618 of the multipliers 9300 and 9301 may be selected using the multiplexers 9412 and 9413. Thus, an output vector may be provided during every cycle.

FIG. 13H illustrates an exemplary structure 1380 of seamless horizontal and vertical integration of multi-core functional modules. As shown in FIG. 13H, additional multi-core functional modules may be integrated horizontally or vertically, and a large number of functional blocks can be interconnected, using direct signal lines or indirectly storage units.

In a multi-core environment, although the above examples show interconnected functional modules from different CPU cores are interconnected to form a new function module with extended functionalities, a single or basic functional module may be formed by using available functional blocks from different processor cores. Further, in a multi-core environment, instructions addressing the operation sequences may be implemented in a distributed computing environment instead of a single instruction set in one CPU core.

Further, as previously mentioned, in both a single core and multi-core environments, various control parameters can be defined to setup configurations of the various functional blocks or functional modules such that the CPU can determine that a particular instruction is for a special operation (i.e., a condense operation). A normal CPU which does not support such special operations can not execute the particular instructions. However, if the CPU is a reconfigurable CPU, the CPU can switch to a reconfigurable mode to invoke the instructions for the special operations.

Thus, the special operation may be invoked in different ways. For example, a normal program calls a particular instruction for a special operation sequence which has been pre-loaded into a storage unit (e.g., storage unit 600). When the CPU executes the program to the point of the particular instruction, the CPU switches to the reconfigure mode in which the particular instruction controls the special operation. When the special operation completes, the CPU comes out of the reconfigurable mode and returns to normal CPU operation mode. Alternatively, certain addressing mechanisms, such as reading from or writing to a register, may be used to address the desired operation sequence in the storage unit.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

### INDUSTRIAL APPLICABILITY

The disclosed system and methods may be used in various digital logic IC applications, such as general processors, special-purpose processors, system-on-chip (SOC) applications, application specific IC (ASIC) applications, and other computing systems. For example, the disclosed system and methods may be used in high performance processors to improve functional block utilization as well as overall system efficiency. The disclosed system and methods may also be used as SOC in various different applications such as in communication and consumer electronics.

### SEQUENCE LIST TEXT

1. A reconfigurable processor, comprising:
a plurality of functional blocks configured to perform corresponding operations;
one or more data inputs coupled to the plurality of functional blocks to provide one or more operands to the plurality of functional blocks;
one or more data outputs to provide at least one result outputted from the plurality of functional blocks; and
a plurality of devices configured to inter-connect the plurality of functional blocks such that the plurality of functional blocks are independently provided with corresponding operands from the data inputs and individual results from the plurality of functional blocks are independently feedback as operands to the plurality of functional blocks to carry out one or more operation sequences.

2. The reconfigurable processor according to claim 1, wherein:
when a data stream is applied to the data inputs, the plurality of functional blocks is further configured to perform a particular operation sequence from one or more operation sequences on consecutive data items of the data stream in a pipelined manner.

3. The reconfigurable processor according to claim 1, wherein:
an operation sequence from the one or more operation sequences include one operation from each of selected functional blocks from the plurality of functional blocks.

4. The reconfigurable processor according to claim 1, wherein:
the plurality of devices include a plurality of multiplexers, a plurality of pipeline registers, and a plurality of control signals.

5. The reconfigurable processor according to claim 1, further including:
a control logic coupled to predetermined functional blocks from the plurality of functional blocks to generate the control signals.

6. The reconfigurable processor according to claim 5, further including:
a counter configured to be controlled by the control logic for setting a number of loops of one or more instructions.

7. The reconfigurable processor according to claim 1, wherein:
the processor decodes instructions to generate configuration information for configuring the plurality of devices with respect to inter-connection of the plurality of functional blocks.

8. The reconfigurable processor according to claim 1, further including:
a storage unit configured to store configuration information for configuring the plurality of devices with respect to inter-connection of the plurality of functional blocks.

9. The reconfigurable processor according to claim 8, wherein:
the configuration information is updated during run-time to change the inter-connection of the plurality of functional blocks.

10. The reconfigurable processor according to claim 8, wherein:
the configuration information includes a plurality of sets of control parameters, each of which corresponds to a particular operation sequence.

11. The reconfigurable processor according to claim 8, wherein:
the storage unit is addressed by an inputted address to read out a corresponding set of control parameters for a particular operation sequence.

12. The reconfigurable processor according to claim 8, wherein:
the storage unit is addressed by a decoded instruction to read out a corresponding set of control parameters for a particular operation sequence.

13. The reconfigurable processor according to claim 9, wherein:
the decoded instruction indicates a normal operation mode and a condense operation mode for the reconfigurable processor.

14. A reconfigurable processor, comprising:
a plurality of processor cores including at least a first processor core and a second processor core; and
a plurality of connecting devices configured to inter-connect the plurality of processor cores,
wherein both the first and second processor cores have a plurality of functional blocks configured to perform corresponding operations;
the first processor core is configured to provide a first functional module using one or more of the plurality of functional blocks of the first processor;
the second processor core is configured to provide a second function module using one or more of the plurality of functional blocks of the second processor; and
the first function module and the second functional module are integrated based on the plurality of connecting devices to form a multi-core functional module.

15. The reconfigurable processor according to claim 14, wherein:
the plurality of connecting devices include at least one of a storage unit for coupling the plurality of processor cores, a plurality of buses for directly coupling adjacent processor cores, and a cross-bar switch for inter-connecting the plurality of processor cores.

16. The reconfigurable processor according to claim 14, wherein:
the plurality of connecting devices include a plurality of multiplexers, a plurality of pipeline registers, and bus lines.

17. The reconfigurable processor according to claim 16, wherein:
the plurality of connecting devices further include a first-in-first-out (FIFO) buffer comprising register files or memory from the processor cores.

18. The reconfigurable processor according to claim 14, further including:
a third processor core and a fourth processor core both having a plurality of functional blocks configured to perform corresponding operations,
wherein the third processor core is configured to provide a third functional module using one or more of the plurality of functional blocks of the third processor;
the fourth processor core is configured to provide a fourth functional module using one or more of the plurality of functional blocks of the fourth processor; and
the third function module and the fourth functional modules are integrated into the multi-core functional module based on the plurality of connecting devices to carry out one or more particular operation sequences.

19. The reconfigurable processor according to claim 14, wherein:
a first pre-determined number of the plurality of processor cores are configured as control modules;
a second pre-determined number of the plurality of processor cores are configured to provide functional modules; and
the control modules and the functional modules exchange data through the plurality of connecting devices to realize a system-on-chip (SOC) configuration.

20. The reconfigurable processor according to claim 14, further including:
a multiplexer configured to select inputs from different functional blocks in different processor cores from the plurality of processor cores, wherein the multiplexer is controlled by configuration information stored in a storage unit.

21. The reconfigurable processor according to claim 14, further including:
a storage unit configured to store configuration information for configuring the plurality of connecting devices with respect to inter-connection of the plurality of processor cores.

22. The reconfigurable processor according to claim 14, wherein:
the one or more particular operation sequences include a fast Fourier transfer (FFT) calculation sequence.

23. The reconfigurable processor according to claim 14, wherein:
the one or more particular operation sequences include a finite impulse response (FIR) calculation sequence.

24. The reconfigurable processor according to claim 14, wherein:
the one or more particular operation sequences include a matrix transformation operation calculation sequence.
